(19) United States
(12) Patent Application Publication
(10) Pub. No.: US 2007/0279670 A1
(43) Pub. Date: Dec. 6, 2007

(54) CLIENT APPARATUS, SERVER APPARATUS, COMPUTER-READABLE MEDIUM, AND COMPUTER DATA SIGNAL

(75) Inventor: Takashi Hiruma, Tokyo (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/566,777

(22) Filed: Dec. 5, 2006

(30) Foreign Application Priority Data
May 30, 2006 (JP) 2006-150054

(51) Int. Cl. G06K 15/00

(52) U.S. Cl. 358/1.14

(57) ABSTRACT

There is provided a client apparatus including a data acquisition unit that acquires, from a server apparatus, output job data generated by the server apparatus, an attribute acquisition unit that acquires attribute information deriving from the client apparatus, and a first output unit that associates the attribute information deriving from the client apparatus with the output job data in accordance with a first correlation scheme for enabling an output device to recognize the attribute information as information to be logged therein, to thereby output to the output device the attribute information associated with the output job data.

### PRIORITY INFORMATION

This application claims priority from Japanese Patent Application No. 2006-150054, filed on May 30, 2006.

### BACKGROUND

1. Technical Field

The present invention relates to document output processing for causing an output device to output an electronic document present on a server apparatus in accordance with an instruction from a client apparatus.

2. Related Art

Recently, a technology known as Server Based Computing (SBC) has come into widespread use. SBC is a mode in which a server centrally manages client applications which were formerly executed by a client computer in a conventional client server system. Known examples of SBC environments include a terminal service provided by Windows (registered trademark) server series operating systems manufactured by Microsoft (registered trademark) Corporation, and Metaframe (registered trademark) manufactured by Citrix Systems, Inc.

In an SBC environment, information regarding events, such as key strokes or mouse clicks, occurring in a client is sent to a server for reflecting the information on an application program running on the server. Then, information regarding changes in a screen of the application program is sent back to the client, and the client updates its own screen on the basis of the information and displays the updated screen. With such a mechanism, users can operate an application on the server as if the application were running on the client.

However, when the user attempts to activate, from the application, a local printer located in the vicinity of the client for printing, problems arise, such as a necessity that appropriate programs be installed in the server, including a printer driver for the local printer.

To prevent occurrence of such a necessity in an environment using the above-described terminal service function or Metaframe (registered trademark), a logical printer (also referred to as a “virtual printer”) corresponding to a client logical printer is generated in a server when a client logs on the server, to thereby realize a capability that printing on the client local printer is enabled from an application installed on the server simply by transferring to the client logical printer a print job from the logical printer on the server.

Printer devices generally record in their respective logs execution results of print processing and other data. In recent years, the logs of printer devices have been analyzed in terms of information security within corporations, in order to perform investigation or examination as to which document has been printed by whom. However, because the server generates a print job in the SBC environment, there has been a case where the server is recorded as a sender of the print job in the log of the printer device in place of the client that is actually used by a user. Further, there are some servers that will rename documents created by an application at the time of transmission of the documents to printer devices. When such servers are used, document names recorded in the logs sometimes will differ from original names specified by users.

### SUMMARY

In an aspect of the present invention, there is provided a client apparatus including a data acquisition unit that acquires, from a server apparatus, output job data generated by the server apparatus, an attribute acquisition unit that acquires attribute information deriving from the client apparatus, and a first output unit that associates the attribute information deriving from the client apparatus with the output job data in accordance with a first correlation scheme for enabling an output device to recognize the attribute information as information to be logged therein, to thereby output to the output device the attribute information associated with the output job data.

### BRIEF DESCRIPTION OF THE DRAWINGS

Exemplary embodiments of the present invention will be described in detail by reference to the following figures, wherein:

FIG. 1 shows an example configuration of a system in a server based computing (SBC) environment;

FIG. 2 shows a functional structure of a client in an example of the system;

FIG. 3 shows a functional structure of a server according to an exemplary embodiment;

FIG. 4 is a drawing for explaining an example of a method for internally adding attributes to print job data;

FIG. 5 is a drawing for explaining an example of another method for externally adding attributes to print job data;

FIG. 6 shows an example of data generated by externally adding the attributes to the print job data;

FIG. 7 shows an example of data generated by individually adding the attributes externally or internally to the print job data; and

FIG. 8 shows an example of a hardware configuration of a computer functioning as a server or a client.

### DETAILED DESCRIPTION

By reference to the drawings, an exemplary embodiment of the present invention will be described below. In the drawings, identical or similar components are identified with the same reference numerals.

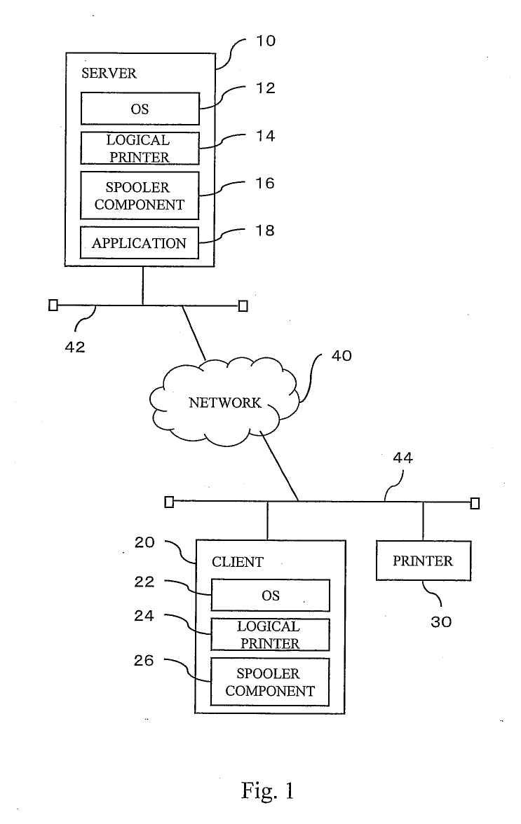

In light of a print function, a system in a server based computing (SMB) environment may have a configuration as shown in FIG. 1. The system includes a server 10 and a client 20. The server 10 is connected to a local area network (LAN) 42, and the client 20 is connected to a LAN 44. The LANs 42 and 44 are connected to each other on a network 40 such as the Internet. A printer (a physical print device) 30 present in a local environment of the client 20 is connected to the client 20. Although in the example illustrated in FIG. 1 the printer 30 is connected to the same LAN 44 that the client 20 is connected to, connection between the printer 30 and the client 20 is not limited to the illustrated configuration, and the printer 30 may be connected directly to a printer port of the client 20.

The server 10 is an apparatus for providing the SBC environment, and examples thereof are Windows (registered trademark) terminal servers manufactured by Microsoft (registered trademark) Corporation and Metaframe (registered trademark) servers. Meanwhile, the client 20 is an apparatus that logs on the server 10 to use the server 10, and one example of such an apparatus is a Windows (registered trademark) client. A user logs on the server 10 from the client 20 and uses an application 18 present on the server 10. In the SBC environment, when an attempt is made to print on a printer an electronic document generated by the application 18 (i.e. document data, hereinafter simply referred to as a “document”), the server 10 generates print job data which can be interpreted by the printer.

The client 20 has an operating system (OS) 22 adaptable to the SBC environment, a logical printer 24 corresponding to the printer 30 present in the local environment, and a spooler component 26. The logical printer 24 may include a printer driver used for transforming a document into print job data described in a language that can be interpreted by the printer 30, such as a page-description language (PDL). The spooler component 26 is a module for temporarily storing (i.e. spooling) the print job data and sending the print job data to the printer 30.

The server 10 includes an OS 12 having a function of providing the SBC environment, a logical printer 14, and a spooler component 16. The logical printer 14 transforms the document created by the application 18 into print job data which can be interpreted by the printer 30 present in the local environment of the client 20. The logical printer 14 has a function similar to that of the logical printer 24 in the client 20. When the client 20 logs on the server 10, for example, the server 10 obtains information regarding the logical printer 24 contained in the client 20, and generates the logical printer 14 having the function similar to that of the logical printer 24. For example, Metaframe (registered trademark) servers include such a generation function. The spooler component 16 spools-the print job data which are generated by the logical printer 14 and directed to the client 20.

In the above-described system, a print job generated by the logical printer 14 of the server 10 is sent via the spooler component 16 to the spooler component 26 of the client 20, and sent further from the spooler component 26 to the printer 30.

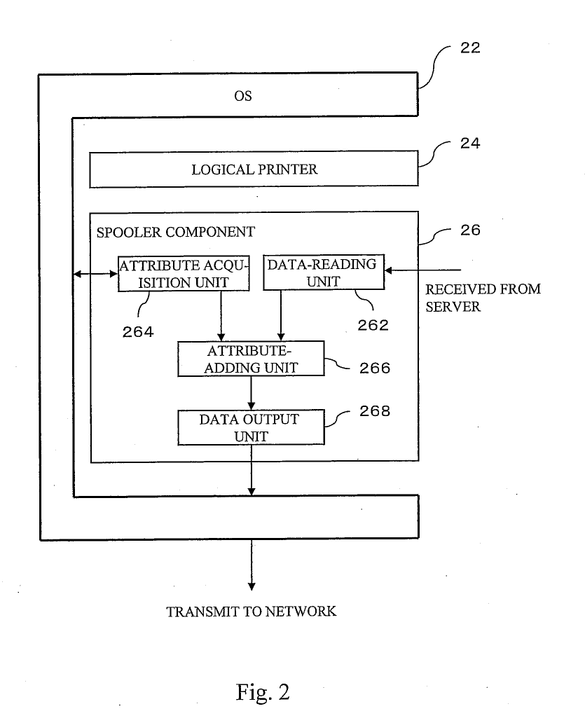

In an example of the system, the spooler component 26 in the client 20 has a function of adding attribute information acquired from the client 20 to the print job data received from the server 10 and sending to the printer 30 the print job data having the added attribute information. A functional structure of the client 20 including the above-described spooler component 26 is shown in FIG. 2.

The spooler component 26 has a data-reading unit 262, an attribute acquisition unit 264, an attribute-adding unit 266, and a data output unit 268. The data-reading unit 262 reads the print job data sent from the server 10.

The attribute acquisition unit 264 acquires, from the OS 22, attribute information to be recorded by a printer in a log as a data item of log data corresponding to the print job data. Here, the attribute information to be acquired may include address information of the client 20, a host name of the client 20, a login name in the client 20 of a user who has instructed the printing, or the like. The address information may be an Internet Protocol (IP) address or a Media Access Control (MAC) address. The login name in the client 20 of the user is a login name (or a user ID) used by the user to log on the client 20, and may differ from that used by the user to log on the server 10. The OS 22 manages information such as the user name of the user who has instructed the printing in a state where the information is associated with a job ID (identification information) of the print job data. In this case, the attribute acquisition unit 264 can acquire the attributes through an inquiry issued to the OS 22 by reference to the job ID of the print job data. Further, because the OS 22 stores the address information and the host name of the client 20, the attribute acquisition unit 264 can obtain the information if necessary. In a case where the OS 22 receives a document name of the print job data from the server 10 and associates the document name with the job ID to manage the document name along with the job ID, the document name may be acquired by the attribute acquisition unit 264.

The above-described attribute items including the address information, the host name, and the login name of the user are described merely as examples. The attribute acquisition unit 264 may acquire one or two of the attribute items, or may acquire attribute items other than those described above. Information for identifying attribute items to be acquired is predefined in the attribute acquisition unit 264.

The attribute-adding unit 266 adds the attribute information acquired by the attribute acquisition unit 264 to the print job data read by the data-reading unit 262. The addition of the attribute information to the print job data is performed in accordance with a scheme similar to a way in which the printer 30 records the attribute information in a log thereof. The scheme for the addition depends on a program used for recording the log by the printer 30.

The client 20 sends the print job data to the printer 30 using a print protocol such as lpr. In many print protocols, a file name (or a document name) of the print job data is sent from a client to a printer as an argument of a print instruction command. In some print protocols, information items including the login name of the user, the address information of the client 20, or the like may be sent as arguments of a print command or other processing commands. A log-recording program in the printer 30 records, in the log, items previously specified from among the information items sent from the client 20 using the protocol as described above together with other information items, such as the date and time at which print processing is performed or a result (success, failure, or other status) of the print processing. Some log-recording programs to be used as the log-recording program of the printer 30 record, in the log, data items of the print job data, such as those previously specified from among data items contained in the job control data described in a control information description language, such as a Printer Job Language (PJL). Information items to be recorded into the log are selected from among information items sent by the protocol and contained in the print job data in accordance with the type or the settings of the log-recording program in the printer 30. The attribute-adding unit 266 adds the attribute information in accordance with a scheme adapted to the type or the settings of the log-recording program in the printer 30.

In a scheme, for example, the attribute information is written into the job control data contained in the print job data. In the print job data including both the job control data and print data in which information to be printed is described in PDL, the attribute item to be recorded in the log is written into the job control data. The login name of the user in the client 20, the IP address of the client 20, and the host name of the client 20, for example, may be described in PJL as shown below:

### DESCRIPTION EXAMPLE 1

PJL SET USER=“MyName”

PJL SET ADDRESS=“222.222.222.222”

PJL SET HOST=“My PC”

In Description Example 1, the first line denotes that the login name of the user (used for logging on the client 20) is “MyName,” the second line denotes that the IP address of the client 20 is “222.222.222.222,” and the third line denotes that the host name of the client 20 is “My PC.”

The attribute-adding unit 266 generates the description as indicated above from values of the attribute items obtained from the OS 22 by the attribute acquisition unit 264, and incorporates the values into the job control data contained in the print job data received from the server 10.

Upon receipt from the client 20 of the print job data including such job control data, the printer 30 initiates print processing in accordance with the received print job data. The log-recording program in the printer 30 logs the print processing. Both values to be retrieved from the job control data contained in the print job data and items of log data on which the retrieved values are recorded as a log are described in the log-recording program of the printer 30. The log-recording program may include description of procedural steps or rules defining, for example, that when a description “@PJL SET USER=” is found in the print job data, a character string subsequent to the description is recorded as a user name in the log. Upon receipt of the print job data, the log-recording program extracts appropriate attribute items from the job control data contained in the received print job data, to thereby record the extracted attribute items in the log.

In the above-described example, the spooler component 26 of the client 20 incorporates into the job control data the attributes deriving from the client 20 selected from among print job attributes, while the printer 30 retrieves values of the attributes deriving from the client 20 from the job control data and records the values in the log.

Here, in some instances, the logical printer 14 or the spooler component 16 in the server 10 might write in the job control data of the print job data the login name of the user in the server 10, the IP address and the host name of the server 10, and other data items in a manner as shown in Description Example 2 below.

### DESCRIPTION EXAMPLE 2

PJL SET USER=“LoginName”
PJL SET ADDRESS=“111.111.111.111”
PJL SET HOST=“My HOST”

In such a case, in order to leave attribute information regarding the client 20 in the log of the printer 30, the attribute-adding unit 266 may replace, in the job control data of the print job data received from the server 10, the values of the attribute items which ought to be recorded in the log with those obtained by the attribute acquisition unit 264, for rewriting new contents as shown in Description Example 1. Regarding the login name of the user, for example, the description “LoginName” specified by the server 10 may be changed to the login name “MyName” used for logging on the client 20.

When the server 10 does not incorporate the attribute items into the job control data, the attribute-adding unit 266 can add the obtained values of the attribute items to the job control data.

In this example, when the server 10 includes values of attributes deriving from the server 10 itself in the job control data, the spooler component 26 of the client 20 rewrites the job control data, replacing the values of the attributes deriving from the server 10 with the values deriving from the client 20. On the basis of such rewritten job control data, the printer 30 records, in the log, information deriving from the client 20 (such as the address information of the client 20 or the login name of the user in the client 20).

It is also conceivable that the printer 30 is of a type which accepts the address information and the host name of both the server 10 and the client 20 in the form of the PJL description and records them in the log. In this case, the attribute-adding unit 266 may describe attribute information representing an address and the host name of the client 20 in PJL and add the attribute information of the client 20 to attribute information (Description Example 2) incorporated by the server 10. The attribute information obtained through the addition is as follows:

### DESCRIPTION EXAMPLE 3

PJL SET USER=“LoginName”
PJL SET ADDRESS=“111.111.111.111”
PJL SET HOST=“My HOST”
PJL SET CLIENTADDRESS=“222.222.222.222”
PJL SET CLIENTHOST=“My PC”

The above Description Example 3 defines that character strings subsequent to “@PJL SET ADDRESS=” and “@PJL SET HOST=” represent the IP address and the host name of the server 10, respectively, whereas character strings subsequent to “@PJL SET CLIENTADDRESS=” and “@PJL SET CLIENTHOST=” represent the IP address and the host name of the client 20, respectively. According to such definition, the log-recording program in the printer 30 may extract the values of attribute items from the print job data and record the values in the log.

As described above, when the attribute-adding unit 266 obtains from the server 10 an attribute relating to a print job, the attribute may be incorporated into the job control data. For example, in a case where the printer 30 records in the log a document name having been incorporated into the job control data, when the document name of the document to be printed is sent from the server 10, the attribute-adding unit 266 may incorporate the document name into the job control data. When the attributes relating to the client 20 need not be recorded in the log of the printer 30, it may be the case that only the attributes received from the server 10 are incorporated into the job control data.

Although in the above-described example the attributes are incorporated into the job control data, the attribute-adding unit 266 may write the attributes into print data, so long as the printer 30 has a capability of reading attribute information described in the print data written in the PDL and recording the attribute information in the log. As such, the attribute-adding unit 266 may add, to a portion of the print job data where the printer 30 can recognize the attributes as a log item, the attributes described in a description format which can be recognized as the log item.

Further, the attributes may be sent as information items of data other than the print job data in the information items sent from the client 20 to the printer 30 using the print protocol. Such information items include the arguments of the print command. When the printer 30 records in the log the information items described above, the attributes are sent as the information items. For example, in a certain print protocol, if the IP address of a host can be sent as an argument of the print command and the argument is recorded in the log by the printer 30, the attribute-adding unit 266 may transmit the IP address of the client 20 as the argument of the print command.

In the lpr protocol, a document name may be sent as an argument of the print command. Accordingly, the attribute-adding unit 266 may specify the document name to the argument of the print command, so long as the printer 30 records in the log the document name serving as the argument. The document name can be obtained from the print job data or other data sent from the server 10 that has generated the print job data. For example, the server 10 may simply write in the job control data the document name of a document to be printed. Alternatively, the server 10 may send the document name as a file name of the print job data to be sent to the client 20 (for example, as an argument of a transmission command) separately from the print job data.

The attribute items may be transmitted in a state where some of the attribute items are incorporated into the print job data, whereas the other attribute items are incorporated into data other than the print job data. In this case, the attribute-adding unit 266 may incorporate into the print job data the attribute items to be extracted from the print job data by the printer 30 while incorporating into the data other than the print job data the attribute items to be extracted from the data other than the print job data.

Next will be described another example.

When a user operates the client 20 to instruct printing of a certain document which is present on the server 10, the logical printer 14 in the server 10 creates print job data. Then, the print job data are transmitted via the spooler component 16 to the client 20. Here, there are some logical printers to be used as the logical printer 14 which might retrieve attributes of the document, the server 10, the user who has instructed the printing, and other items from the OS 12, or from the application 18 via the OS 12 and incorporate the retrieved attributes into the print job data. The attributes of the document include, for example, the document name, a name of a creator who has created the document, and the like. Meanwhile, the attributes of the server 10 include the host name, address information of the server 10, and the like. Further, the attributes of the user that can be retrieved in the server 10 include the login name of the user having logged on the server 10, for example. An example of an attribute section in the generated job control data is shown below:

### DESCRIPTION EXAMPLE 4

PJL SET USER=“LoginName”
PJL SET DOCUMENT=“My Schedule”
PJL SET ADDRESS=“111.111.111.111”
PJL SET HOST=“My HOST”

In Description Example 4, the first line represents the login name for the server 10, the second line represents the document name, the third line represents the IP address of the server 10, and the fourth line represents the host name of the server 10.

Here, in transmission of the print job data to the client 20, the server 10 may send, in some cases, some or all of the attribute items deriving from the server 10 as data transmitted in a protocol for the transmission (for example, arguments of a transmission command). For example, the document name may be specified as a file name of the print job data, and the file name may be sent as data transmitted in a transmission protocol when the print job data are sent to the client 20. However, there is a possibility that, at a time when the spooler component 16 sends to the client 20 both the print job data and the data transmitted in the protocol as described above, the OS 12 of the server 10 or a communication protocol running under the OS 12 (hereinafter simply referred to as “the OS 12 or the like”) will rewrite the data transmitted in the protocol.

In a case where the server 10 is a MetaFrame (registered trademark) server, it is known that during a process of sending the print job data from the server 10 to the client 20, the OS 12, or the like replaces an intrinsic document name of the document to be printed with another specific name. In this case, the client 20 is unable to obtain the intrinsic document name of the document to be printed unless the intrinsic document name is contained in the print job data. In addition, because the print job data received by the client 20 always have the same particular name assigned by the server, even if the printer 30 records the particular name of the print job data in the log, anything specific may fail to be recognized from the recorded name.

Accordingly, in the present example, the spooler component 16 includes values of such protocol data which ought to be rewritten into the print job data, to thereby circumvent the rewriting of the values.

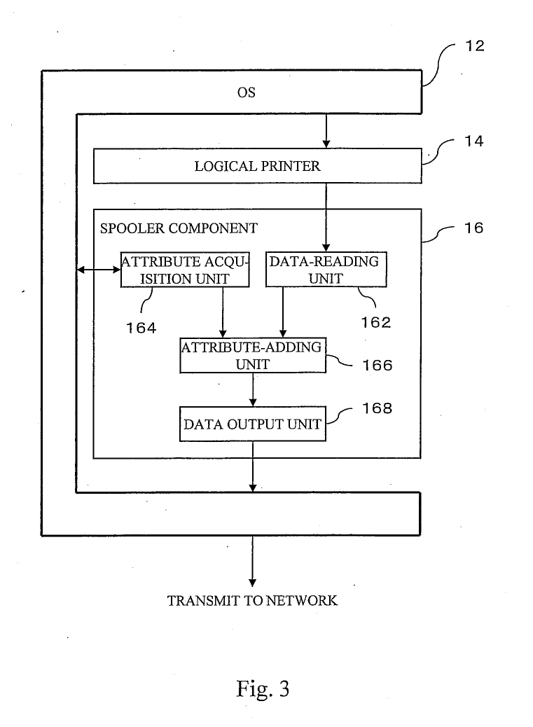

In this example, the spooler component 16 of the server 10 has, as shown in FIG. 3, a data-reading unit 162, an attribute acquisition unit 164, an attribute-adding unit 166, and a data output unit 168.

The data-reading unit 162 reads the print job data generated by the logical printer 14 in accordance with the print instruction. The attribute acquisition unit 164 retrieves attributes which are not incorporated into the print job data by the logical printer 14 and which are rewritten by the OS 12 or the like at the time of transmission from among the attributes which derive from the server 10, and are to be logged by the printer 30, and receives the retrieved attributes from the OS 12. Here, the attributes to be retrieved may include the name of the document to be printed, the address information and the host name of the server 10, and the login name in the server 10 used by the user who has instructed the printing. The OS 12 may manage the document name and the name of the user who has instructed the printing in a state associated with the job ID (identification information) of the print job data. In this case, the attribute acquisition unit 164 can send to the OS 12 an inquiry using the job ID of the print job data, to thereby acquire the above-described attributes. Further, because the OS 12 has the address information and the host name of the server 10, the attribute acquisition unit 164 is capable of acquiring them from the OS 12.

The attribute items described above are presented merely as examples, and the attribute acquisition unit 164 may obtain one or two of the attribute items, or may obtain attribute items other than those described above. Information for identifying the attribute items which should be obtained is previously established in the attribute acquisition unit 164.

The attribute-adding unit 166 adds the attribute information acquired by the attribute acquisition unit 164 to the print job data read by the data-reading unit 162. As a method for adding the attribute information to the print job data, a method of incorporating the attribute information into the print job data may be used.

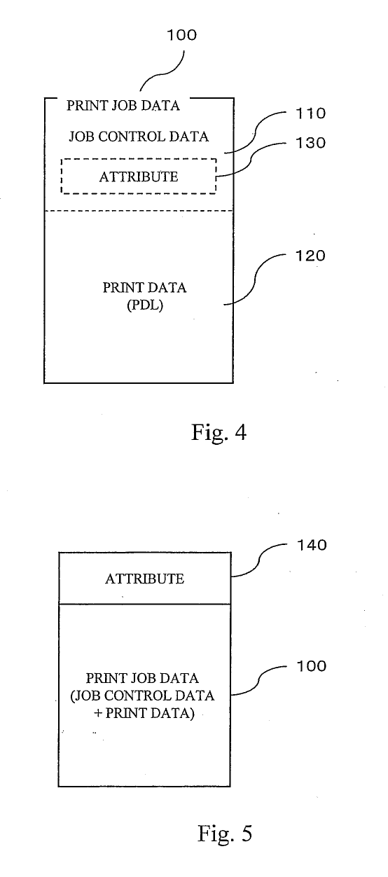

In this method, an attribute 130 to be added is included into job control data 110 which constitute a part of print job data 100 as shown in FIG. 4, for example. In this case, the description such as that shown in the above-described Description Example 4 may be included into the job control data 110. After that, the spooler component 26 of the client 20 may extract an appropriate attribute; i.e. the attribute 130, from the job control data 110, and transfer the attribute 130 to the printer 30 in a format in which the printer 30 can recognize the attribute 130 as an object to be recorded in the log. The spooler component 26 of the client 20 may remove, from the print job data 100, the attribute 130 extracted from the job control data 110 and send to the printer 30 the print job data 100 from which the attribute 130 is removed. Alternatively, the attribute-adding unit 166 may include the attribute into the print data 120 when the spooler component 26 in the client 20 is able to extract the attribute from the print data 120 described in PDL within the print job data 100.

As the method for adding the attribute into the print job data, there may be used another method in which attribute data 140 are added to the outside of the print job data 100 generated by the logical printer 14 as shown in FIG. 5. In this method, the print job data 100 and the attribute data 140 may be integrated into a single file. Alternatively, the attribute data 140 may be attached as a header to the print job data 100.

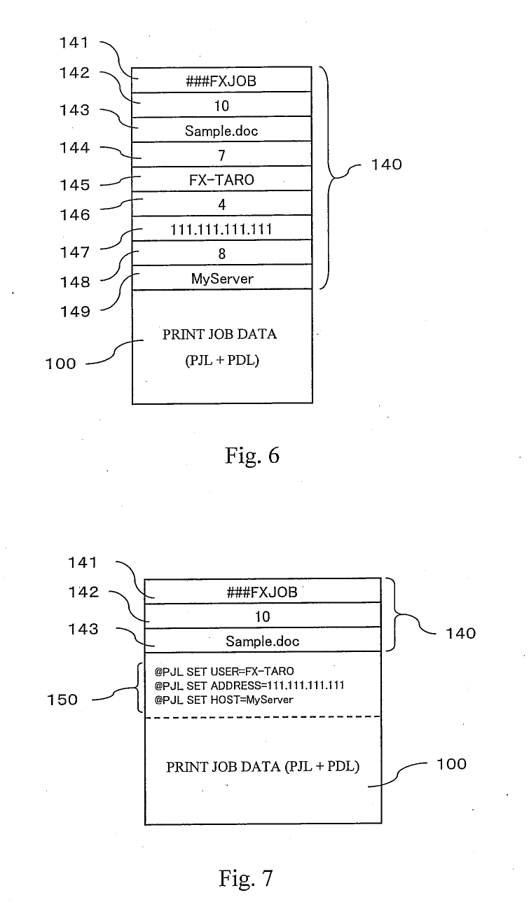

FIG. 6 shows example items of the attribute data 140 in this method. In the example of FIG. 6, the attribute data 140 include, at a predetermined position (at the top of the attribute data 140 in the example of FIG. 6), identification information 141 representing that accompanying data are the attribute data 140 added to the print job data 100. Further, the attribute data 140 include values 143, 145, 147, and 149 of the attribute items, each of which is associated with a value 142, 144, 146, or 148 representing a data size of the corresponding attribute item. In the example of FIG. 6, on an item-by-item basis, the data size of an attribute item is directly followed by the value of the attribute item. The data size is data composed of a predetermined number of bits (for example, 1 byte=8 bits). The listing order of the attribute items is predetermined. The attribute-adding unit 166 of the server 10 arranges the data sizes and values of the attribute items in the predetermined listing order, whereas the attribute-adding unit 266 of the client 20 recognizes each value of the attribute items in accordance with the listing order.

For example, the value 143, “Sample.doc” of the attribute item is a name of a document to be printed, and the data size of the attribute item is 10 bytes as shown in the value 142. In addition, the value 145 is the login name of the user in the server 10, the value 147 is the IP address of the server 10, and the value 149 is the host name of the server 10.

Although FIG. 6 shows the example in which the server 10 adds the login name of the user, the IP address, and the host name of the server 10, it may be the case that the server 10 adds only attribute items to be logged by the printer 30, and does not necessarily add all of the attribute items. Further, the server 10 may add attribute items other than those described above.

Upon detection of the identification information 141 in the data received from the server 10, the data-reading unit 262 of the client 20 recognizes predetermined bits of data following the identification information 141 as the data size 142, recognizes subsequent data following the data size 142 and having a size indicated by the data size 142 as a value of the first attribute item, and passes the value to the attribute-adding unit 266. Then, the data-reading unit 262 determines whether or not data subsequent to the first attribute item are the print job data 100. When the subsequent data are not the print job data 100, the data-reading unit 262 recognizes a first element of the subsequent data as a data size, recognizes a second element following the data size and having a size indicated by the data size as a value of the second attribute item, and passes the value to the attribute-adding unit 266. The data-reading unit 262 repeats such processing until reaching the print job data 100. Operation of the attribute-adding unit 266 may be similar to that described above.

Up to this point, internal addition and external addition of the attributes to the print job data are exemplified as the method for adding the attributes to the print job data. Still another method which is intermediate between the internal addition and the external addition may be used. In an example depicted in FIG. 7, among the attribute items, the document name 143 is added as attribute data 140 to the outside of the print job data 100, whereas the login name of the user and the IP address and the host name of the server 10 are added as attribute data 150 into the job control data contained in the print job data. Whether the attribute items are internally added or externally added to the print job data and the listing order of the attribute items are previously determined in the form of a rule, and the attribute-adding unit 166 adds each of the attribute items in accordance with the rule. Meanwhile, the data-reading unit 262 of the client 20 acquires, in accordance with the rule, each value of the attribute items in the attribute data 140 and the attribute data 150 existing inside and outside the print job data 100, respectively. In this case, operation of the attribute-adding unit 266 may be similar to that described above.

The data output unit 168 outputs to the client 20, via the OS 12, the print job data having the added attributes. Accordingly, the attributes added to the print job data are transmitted to the client 20 without being changed even when the OS 12 makes a modification to data transmitted by means of a protocol defined for communication with the client 20.

In the examples described above, each of the spooler components 16 and 26 may be configured, for example, as a Windows (registered trademark) print processor. In this case, a print processor having the function of the spooler component 16 is installed in the server 10, Whereas a print processor having the function of the spooler component 26 is installed in the client 20.

In addition, the client 20 has the logical printer 24 installed therein. The logical printer 14 of the server 10 may be installed in the server 10, or may instead be generated by the server 10 on the basis of the information of the logical printer 24 when a user logs on the server 10 through operation of the client 20. Because MetaFrame (registered trademark) servers have the function of generating a logical printer, the logical printer 14 can be automatically generated when a Metaframe (registered trademark) server is used as the server 10. As the logical printers 24 and 14, conventional logical printers may be used. The logical printer 24 of the client 20 is used as a model of the logical printer 14 when the server 10 automatically generates the logical printer 14, but is not used directly for issuing the print instruction to the printer 30. Therefore, when the logical printer 14 is pre-installed in the server 10 rather than being generated automatically, the logical printer 24 is not necessarily needed.

If a print processor including the spooler component 16 (for the sake of simplicity, hereinafter referred to as a “print processor A”) is not defined as the default print processor for the server, a user who wishes to use the function described in the above examples may call up a property screen of the logical printer 14 after the logical printer 14 is automatically generated, to thereby replace the default print processor with the print processor A. Similarly, when a print processor including the spooler component 26 (hereinafter referred to as a “print processor B”) is not defined as the default print processor of the client 20, the user may call up the property screen of the logical printer 24 to thereby replace the default print processor with the print processor B. The server 10 and the client 20 may be programmed such that the replacement of the print processor to be used is performed automatically when the user logs on the server 10 from the client 20 rather than being explicitly executed by the user.

Although the system for printing and outputting an electronic document from the printer 30 has been described above, the mechanism as described above may be applied also in a case where the electronic document is output to an output device other than the printer, such as a facsimile machine, a copier, or a multifunction machine. In this case, the server 10 generates output job data for causing the output device to output the electronic document and sends the generated output job data to the client 20. Upon receipt of the output job data, the client 20 further transmits the output job data to the output device.

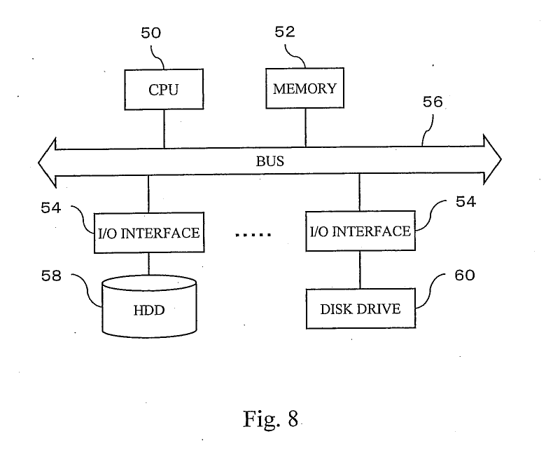

The above-described server 10 is typically realized by executing a program describing the function or process of each element described above on a general-purpose computer. As shown in FIG. 8, the computer has, as hardware, a circuit structure in which a CPU (Central Processor Unit) 50, memory (primary storage) 52, and various I/O (input/output) interfaces 54, or the like, are connected via a bus 56. A hard disk drive 58 or a disk drive 60 for reading transportable, nonvolatile recording media of various standards such as a CD, a DVD, or a flash memory may be connected, for example, via the I/O interfaces 54 to the bus 56. Such drives 58 and 60 function as external storage devices for the memory. A program in which the processes of the server 10 of the exemplary embodiment are described is stored in a fixed storage device such as the hard disk drive 58 via a recording medium such as a CD or DVD or via the network and is installed in the computer. The processes of the exemplary embodiment are realized by the program stored in the fixed storage device being read into the memory and executed by the CPU. In addition, similarly, the client 20 can be realized by an architecture similar to that of the general-purpose computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. A client apparatus comprising:
a data acquisition unit that acquires, from a server apparatus, output job data generated by the server apparatus;
an attribute acquisition unit that acquires attribute information deriving from the client apparatus; and
a first output unit that associates the attribute information deriving from the client apparatus with the output job data in accordance with a first correlation scheme for enabling an output device to recognize the attribute information as information to be logged therein, to thereby output to the output device the attribute information associated with the output job data.

2. The client apparatus according to claim 1, further comprising:
an attribute extraction unit that extracts predetermined attribute information from the output job data acquired by the data acquisition unit; and
a second output unit that associates the attribute information extracted by the attribute extraction unit with the output job data in accordance with a second correlation scheme for enabling the output device to recognize the attribute information as information to be logged therein, to thereby output to the output device the attribute information associated with the output job data.

3. A computer-readable medium storing a program causing a computer to execute a process for controlling an output device, the process comprising:
acquiring, from a server apparatus, output job data generated by the server apparatus;
acquiring attribute information deriving from the computer; and
associating the attribute information deriving from the computer with the output job data in accordance with a first correlation scheme for enabling the output device to recognize the attribute information as information to be logged therein, to thereby output to the output device the attribute information associated with the output job data.

4. The computer-readable medium according to claim 3, wherein the process further comprises:
extracting predetermined attribute information from the output job data acquired from the server apparatus; and
associating the extracted attribute information with the output job data in accordance with a second correlation scheme for enabling the output device to recognize the attribute information as information to be logged therein, to thereby output to the output device the extracted attribute information associated with the output job data.

5. A computer data signal embodied in a carrier wave for enabling a computer to perform a process for controlling an output device, the process comprising:
acquiring, from a server apparatus, output job data generated by the server apparatus;
acquiring attribute information deriving from the computer; and
associating the attribute information deriving from the computer with the output job data in accordance with a first correlation scheme for enabling the output device to recognize the attribute information as information to be logged therein, to thereby output to the output device the attribute information associated with the output job data.

6. The computer data signal according to claim 5, wherein the process further comprises:
extracting predetermined attribute information from the output job data acquired from the server apparatus; and
associating the extracted attribute information with the output job data in accordance with a second correlation scheme for enabling the output device to recognize the attribute information as information to be logged therein, to thereby output to the output device the extracted attribute information associated with the output job data.

7. A method for controlling an output device, comprising:
acquiring, from a server apparatus, output job data generated by the server apparatus;
acquiring attribute information deriving from the computer; and
associating the attribute information deriving from the computer with the output job data in accordance with a first correlation scheme for enabling the output device to recognize the attribute information as information to be logged therein, to thereby output to the output device the attribute information associated with the output job data.

8. The method according to claim 7, further comprising:
extracting predetermined attribute information from the output job data acquired from the server apparatus; and
associating the extracted attribute information with the output job data in accordance with a second correlation scheme for enabling the output device to recognize the attribute information as information to be logged therein, to thereby output to the output device the extracted attribute information associated with the output job data.

9. A client apparatus comprising:
an acquisition unit that acquires from a server apparatus output job data generated by the server apparatus;
an extraction unit that extracts predetermined attribute information from the output job data; and
an output unit that associates the extracted attribute information with the output job data in accordance with a correlation scheme for enabling an output device to recognize the attribute information as information to be logged therein, to thereby output to the output device the extracted attribute information associated with the output job data.

10. A computer-readable medium storing a program causing a computer to execute a process for controlling an output device, the process comprising:
acquiring, from a server apparatus, output job data generated by the server apparatus;
extracting predetermined attribute information from the output job data; and
associating the extracted attribute information with the output job data in accordance with a correlation scheme for enabling the output device to recognize the attribute information as information to be logged therein, to thereby output to the output device the extracted attribute information associated with the output job data.

11. A computer data signal embodied in a carrier wave for enabling a computer to perform a process for controlling an output device, the process comprising:
acquiring, from a server apparatus, output job data generated by the server apparatus;
extracting predetermined attribute information from the output job data; and
associating the extracted attribute information with the output job data in accordance with a correlation scheme for enabling the output device to recognize the attribute information as information to be logged therein, to thereby output to the output device the extracted attribute information associated with the output job data.

12. A method for controlling an output device, comprising:
acquiring, from a server apparatus, output job data generated by the server apparatus;
extracting predetermined attribute information from the output job data; and
associating the extracted attribute information with the output job data in accordance with a correlation scheme for enabling the output device to recognize the attribute information as information to be logged therein, to thereby output to the output device the extracted attribute information associated with the output job data.

13. A server apparatus comprising:
an attribute acquisition unit that acquires attribute information deriving from the server apparatus;
an attribute-adding unit that adds the attribute information acquired by the attribute acquisition unit to output job data which is generated in response to an instruction from a client apparatus and supplied to an output device in accordance with a predetermined addition scheme for enabling the client apparatus to recognize the attribute information as an attribute to be logged in the output device; and
a data output unit that outputs to the client apparatus the output job data including the added attribute information for causing the output device to output the output job data.

14. A computer-readable medium storing a program causing a computer to execute a process for generating output job data in response to an instruction from a client apparatus, the process comprising:
acquiring attribute information deriving from the computer;
adding the acquired attribute information to the output job data which is generated in response to the instruction from the client apparatus and supplied to an output device, in accordance with a predetermined addition scheme for enabling the client apparatus to recognize the acquired attribute information as an attribute to be logged in the output device; and
outputting to the client apparatus the output job data having the added attribute information for causing the output device to output the output job data.

15. A computer data signal embodied in a carrier wave for enabling a computer to perform a process for generating output job data in response to an instruction from a client apparatus, the process comprising:
acquiring attribute information deriving from the computer;
adding the acquired attribute information to the output job data which is generated in response to the instruction from the client apparatus and supplied to an output device, in accordance with a predetermined addition scheme for enabling the client apparatus to recognize the acquired attribute information as an attribute to be logged in the output device; and
outputting to the client apparatus the output job data having the added attribute information for causing the output device to output the output job data.

16. A method for generating output job data in response to an instruction from a client apparatus, comprising:
acquiring attribute information deriving from the computer;
adding the acquired attribute information to the output job data which is generated in response to the instruction from the client apparatus and supplied to an output device, in accordance with a predetermined addition scheme for enabling the client apparatus to recognize the acquired attribute information as an attribute to be logged in the output device; and
outputting to the client apparatus the output job data having the added attribute information for causing the output device to output the output job data.
